(19) United States
(12) Patent Application Publication
(10) Pub. No.: US 2025/0279806 A1
(43) Pub. Date: Sep. 4, 2025

(54) DEVICES AND METHODS FOR EFFICIENT JOINT TRANSMISSION IN A WIRELESS NETWORK

(71) Applicant: HUAWEI TECHNOLOGIES CO., LTD., Shenzhen (CN)

(72) Inventors: Doron Ezri, Munich (DE); Yoav Levinbook, Munich (DE)

(73) Assignee: HUAWEI TECHNOLOGIES CO., LTD., Shenzhen (CN)

(21) Appl. No.: 19/087,240

(22) Filed: Mar. 21, 2025

Related U.S. Application Data
(63) Continuation of application No. PCT/EP2022/076140, filed on Sep. 21, 2022.

(51) Int. Cl. H04B 7/024; H04B 7/0456; H04B 7/08

(52) U.S. Cl. CPC H04B 7/024; H04B 7/0456; H04B 7/0848

(57) ABSTRACT

An access point (AP) is provided for a joint transmission with at least one further AP to a plurality of stations. The AP is configured to determine, based on channel information for the plurality of stations, a respective precoding matrix for a beamed transmission to each of the plurality of stations with substantially zero multi-user interference (MUI) at the respective station and a respective overall channel matrix based on the channel information and the precoding matrix of the respective station; obtain one or more further overall channel matrices of the at least one further AP for one or more first stations of the plurality of stations; and determine, based on the one or more overall channel matrices and the one or more further overall channel matrices, for the AP and the at least one further AP a respective weighting matrix for the transmission to the one or more first stations.

### CROSS-REFERENCE TO RELATED APPLICATIONS

This application is a continuation of International Application No. PCT/EP2022/076140, filed on Sep. 21, 2022, the disclosure of which is hereby incorporated by reference in its entirety.

### TECHNICAL FIELD

Embodiments of the present disclosure relate to wireless communications. More specifically, the embodiments of the present disclosure relate to devices, in particular access points (Aps), and methods for efficient joint transmission in a wireless communication network, in particular a Wi-Fi network.

### BACKGROUND

In joint transmission (JT), which is a promising scheme for increasing throughput (especially to cell edge users) and is considered for extensions of current Wi-Fi standards, several access points (APs) transmit simultaneously to several stations (STAs) by using joint precoding so that the transmissions to different STAs do not interfere with each other. Because of the joint precoding, JT may provide a substantial improvement relative to coordinated beamforming. This improvement, however, comes at the price of JT being a more complex transmission scheme than coordinated beamforming (CoBF). For instance, in JT a master AP may be required to transmit the transmission streams to the other APs via a separate channel. For determining the overall precoder all APs are treated as a single virtual AP. Each AP may obtain its precoder component from the overall precoder.

One further main reason for the increased complexity of JT relative to CoBF is the required synchronization between the APs. This is because a very good phase synchronization between the APs must be maintained, for instance, from the transmission of a pre-transmission null data packet (NDP) to the actual joint transmission. Even a small phase offset of, for instance, about 15 deg (or less) between the APs can lead to significant degradation of the JT.

In uplink (UL) MU-MIMO the synchronization requirement between STAs is that the residual frequency offset (FO) is less than or equal to 350 Hz. Even if the APs can synchronize with much better precision, the phase offset will accumulate to a significant resulting phase offset within several msec. For instance, of a 10 Hz residual FO, the phase offset may accumulate to 18 deg in just 5 msec. Moreover, timing offset of a fractional sample between the APs during the start of transmission of the data packet (relative to sounding) may also cause a significant phase offset.

Some conventional approaches address the sensitivity of JT to phase offset by trying to keep the phase offset to minimum (up to few degrees). For instance, a Master AP for the JT may transmit just prior to the joint transmission a short synchronization packet (preamble), which will allow the other APs to synchronize their phase. If the transmitted packet is very long, the overhead of the synchronization packet may be small, but the phase error will build up over the packet due to residual FO. If the transmitted packet is small, the phase offset problem may be resolved, but at the price of a large communication overhead. For longer packets, it may be even useful to add mid-ambles within the packet, which increases the overhead even more.

### SUMMARY

Embodiments of the present disclosure provide devices, in particular access points (Aps), and methods for an improved joint transmission being less sensitive to phase offsets (due to imperfect synchronization) in a wireless communication network, in particular a Wi-Fi network.

Generally, access points (Aps), and methods are disclosed herein for an improved joint transmission (JT), in a wireless communication network, in particular a Wi-Fi network, being less robust with respect to phase offsets (often due to imperfect AP synchronization). The APs and methods for JT disclosed herein can provide most of the gain of conventional JT relative to CoBF, when there is no phase offset, but still can maintain most of this gain even in the presence of moderate phase offsets between the APs (such as 45 degrees). Thus, as will be appreciated, the APs and methods disclose herein allow significantly easing the synchronization requirements between the APs for performing a JT.

The APs and methods disclosed herein allow guaranteeing substantially zero multi-user interference (MUI), from each AP no matter what its phase-offset relative to the other APs. Moreover, the transmission of the different APs is combined so as to optimize the SNR at the stations receiving the JT (for small phase offsets). Thus, the APs and methods disclosed herein may provide excellent performance for small and moderate phase offsets. Intuitively the APs and methods disclosed herein may be regarded in the following manner. The APs and methods disclosed herein guarantee that the nulls of the precoders used for the JT are substantially insensitive to the phase offsets between the APs and, thus, substantially no MUI. Moreover, the APs and methods disclosed herein implement an optimal alignment of all the JT beams that all APs create towards a respective station (herein referred to as “beam alignment”). Generally, the beam alignment is not optimal for all phase-offsets, and this is designed by the APs and methods disclosed herein to be optimal for the case of no phase offset (based on symmetry considerations). As will be appreciated, while the nulls usually are very sensitive to even a small change in the phase-offset between the APs, the beam is much less sensitive. Thus, even a moderate change in phase-offset (say 45 degrees) does not reduce the SNR much.

As will be described in more detail below, the beam-alignment mentioned above is based on an overall channel matrix from all the APs, where the overall channel matrix, in turn, is based on the channel information and an initial precoder from the corresponding AP to the STA. In principle, each AP may be configured to calculate the overall channel matrix of all the APs to a certain STA and derive the beam-alignment itself. However, this is usually not the most efficient way in terms of total computational complexity of all APs since many calculations are repeated. In more efficient embodiments, the calculations may be distributed over the APs. For this purpose, a STA may be assigned to an AP in the sense that the AP (the STA is assigned to) performs the beam-alignment calculation for the assigned STA (possibly using further information from the other APs). In embodiments, the assignment of STAs to APs should be as uniform as possible. For example, in the case of the same number of APs and STAs, one STA may be assigned to one AP. In an embodiment, a STA may be assigned to an AP by being associated with the AP.

More specifically, according to a first aspect a multi-antenna access point (AP), is provided for a joint transmission with at least one further multi-antenna AP to a plurality of stations, including one or more first stations assigned to the AP and one or more second stations assigned to the at least one further AP.

The AP is configured to determine, based on channel information for each of the plurality of stations, for each of the plurality of stations a respective precoding matrix for a beamed transmission to each of the plurality of stations with substantially zero multi-user interference, MUI, at the respective station and a respective overall channel matrix based on the channel information and the precoding matrix of the respective station.

Moreover, the AP is configured to obtain one or more further overall channel matrices of the at least one further AP for the channel to the one or more first stations assigned to the AP. The AP is further configured to determine, based on the one or more overall channel matrices and the one or more further overall channel matrices, for the AP and the at least one further AP a respective weighting matrix for the transmission to the one or more first stations.

Moreover, the AP is configured to obtain one or more further weighting matrices for the transmission from the AP to the one or more second stations assigned to the at least one further AP. The AP is further configured to determine, i.e. compute for the one or more first stations assigned to the AP a respective weighted precoding matrix based on the respective precoding matrix and the respective weighting matrix determined by the AP for the one or more first stations assigned to the AP and determine for the one or more second stations assigned to the at least one further AP a respective weighted precoding matrix based on the respective precoding matrix and the respective further weighting matrix. Moreover, the AP is configured to perform a joint transmission with the at least one further AP to the plurality of stations based on the weighted precoding matrix for each of the plurality of stations.

In a further possible implementation form, the AP is configured to transmit the one or more overall channel matrices determined by the AP for the one or more second stations assigned to the at least one further AP to the at least one further AP and to obtain the one or more further overall channel matrices of the at least one further AP for the one or more first stations assigned to the AP from the at least one further AP.

In a further possible implementation form, the AP is configured to transmit one or more of the weighting matrices determined by the AP for the transmission from the at least one further AP to the one or more first stations assigned to the AP to the at least one further AP and to obtain one or more of the further weighting matrices for the transmission from the AP to the one or more second stations assigned to the at least one further AP from the at least one further AP.

In a further possible implementation form, the AP is configured to determine for each of the one or more first stations the weighting matrix based on the one or more overall channel matrices and the one or more further overall channel matrices by aligning one or more intensities and/or one or more phases of a respective beamed transmission for maximizing a composite quality metric, in particular a composite post-processing signal-to-noise ratio, SNR.

In a further possible implementation form, the AP is configured to determine for each of the one or more first stations the weighting matrix based on the one or more overall channel matrices and the one or more further overall channel matrices using a QR decomposition of the respective overall channel matrix.

In a further possible implementation form, the AP is configured to receive the channel information directly from the plurality of stations and/or indirectly from the at least one further AP.

In a further possible implementation form, the channel information for each of the plurality of stations comprises a partial channel information and/or a complete channel information.

In a further possible implementation form, the AP is configured to transmit a sounding signal to one or more of the plurality of stations assigned to the AP for triggering the one or more of the plurality of stations assigned to the AP to transmit the channel information to the AP.

In a further possible implementation form, the one or more first stations assigned to the AP are associated with the AP.

In a further possible implementation form, the AP and the at least one further AP are connected by a wired and/or wireless connection, in particular for exchanging at least some of the data mentioned above.

According to a second aspect a method is disclosed of performing a joint transmission with an access point, AP, and at least one further AP to a plurality of stations, including one or more first stations assigned to the AP and one or more second stations assigned to the at least one further AP. The method comprises the steps of.
determining, based on channel information for each of the plurality of stations, for each of the plurality of stations a respective precoding matrix for a beamed transmission to each of the plurality of stations with substantially zero multi-user interference, MUI, at the respective station and a respective overall channel matrix based on the channel information and the precoding matrix of the respective station;
obtaining one or more further overall channel matrices of the at least one further AP for the one or more first stations assigned to the AP;
determining, based on the one or more overall channel matrices and the one or more further channel matrices, for the AP and the at least one further AP a respective weighting matrix for the transmission to the one or more first stations;
obtaining one or more further weighting matrices for the transmission from the AP to the one or more second stations assigned to the at least one further AP;
determining for the one or more first stations assigned to the AP a respective weighted precoding matrix based on the respective precoding matrix and the respective weighting matrix determined by the AP for the one or more first stations assigned to the AP and determining for the one or more second stations assigned to the at least one further AP a respective weighted precoding matrix based on the respective precoding matrix and the respective further weighting matrix of the at least one further AP; and
performing a joint transmission with the AP and the at least one further AP to the plurality of stations based on the weighted precoding matrix for each of the plurality of stations.

The method according to the second aspect of the present disclosure can be performed by the AP according to the first aspect of the present disclosure. Thus, further features of the method, according to the second aspect of the present disclosure, result directly from the functionality of the AP according to the first aspect of the present disclosure as well as its different implementation forms described above and below.

According to a third aspect a computer program product is provided, comprising program code which causes a computer or a processor to perform the method according to the second aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a wireless communication network, including an AP according to an embodiment and a further AP performing a joint transmission to a plurality of stations;

FIG. 2 shows a schematic diagram illustrating a wireless communication network, including an AP according to an embodiment and two further APs performing a joint transmission to a plurality of stations;

FIG. 3 shows a schematic diagram illustrating processing steps and a data exchange implemented by an AP according to an embodiment and a further AP for performing a joint transmission to a plurality of stations;

FIG. 4 shows a flow diagram illustrating steps of a method for performing a joint transmission to a plurality of stations according to an embodiment; and

FIGS. 5a-5e show different graphs illustrating the performance of the JT implemented by an AP according to an embodiment relative to conventional JT and conventional CoBF.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, aspects of embodiments of the present disclosure or aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various embodiments and/or aspects described herein may be combined with each other, unless specifically noted otherwise.

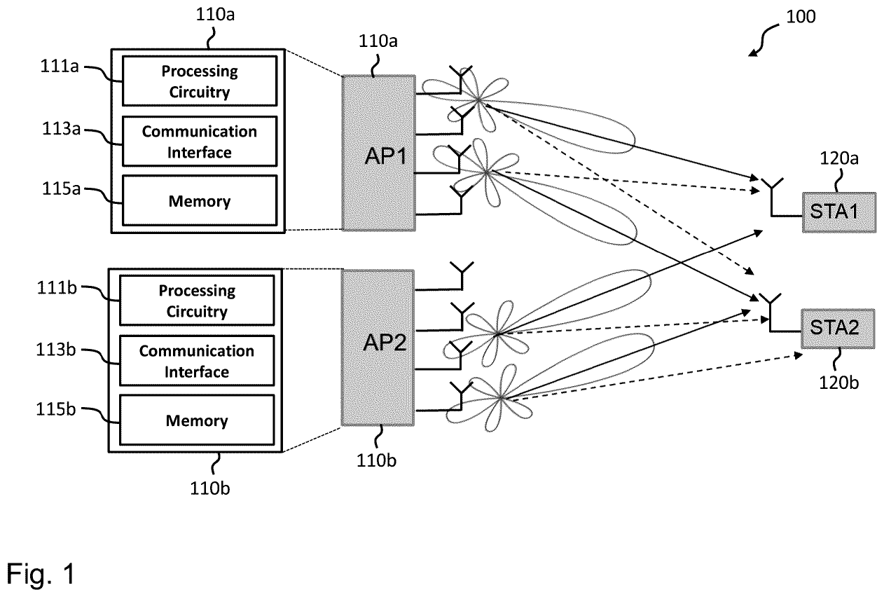

FIG. 1 shows a schematic diagram illustrating a wireless communication network 100, in particular a Wi-Fi network 100, including a multi-antenna access point, AP, 110a according to an embodiment (referred to as AP1 in FIG. 1) and a further mulita-antenna AP 110b according to an embodiment (referred to as AP2 in FIG. 1) performing a joint transmission to two stations 120a,b referred to as STA1 and STA2 in FIG. 1. In the embodiment shown in FIG. 1, STA1 120a may be assigned to the multi-antenna AP, 110a, while STA2 120b may be assigned to multi-antenna AP2 110b. In an embodiment, the STA1 120a may be assigned to the multi-antenna AP1 110a by being associated with the multi-antenna AP1 110a. Likewise, the STA2 120b may be assigned to the further multi-antenna AP2 110b by being associated with the further multi-antenna AP2 110b. As will be described in more detail below, for the joint transmission the APs AP1 and AP2 110a,b are configured to perform a beam-alignment based on an overall channel matrix from all the APs 110a,b, where the overall channel matrix, in turn, is based on the channel information and an initial precoder from the corresponding AP 110a,b to the STA 120a,b. In principle, each AP 110a,b may be configured to calculate the overall channel matrix of all the APs 110a,b to a certain STA 120a,b and derive the beam-alignment itself. However, this is usually not the most efficient way in terms of total computational complexity of all APs 110a,b since many calculations are repeated. In more efficient embodiments, the calculations may be distributed over the APs 110a,b, as will be described in the following. For this purpose, each STA 120a,b may be assigned to an AP 110a,b in the sense that the AP 110a,b (the STA 120a,b is assigned to) performs the beam-alignment calculation for the assigned STA 120a,b (possibly using information from the other APs 110a,b). In embodiments, the assignment of STAs 120a,b to APs 110a,b should be as uniform as possible.

As indicated in FIG. 1, both the multi-antenna AP1 110a and the further multi-antenna AP2 110b according to an embodiment may comprise processing circuitry 111a,b, a communication interface 113a,b and/or a memory 115a,b. The processing circuitry 111a,b of the multi-antenna AP1 110a and the further multi-antenna AP2 110b may be implemented in hardware and/or software. The hardware may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The communication interface 113a,b of the multi-antenna AP1 110a and the further multi-antenna AP2 110b may be configured to enable a mutual communication and/or a communication with the plurality of stations 120a,b based on wired and/or wireless connections. The memory 115a,b of the multi-antenna AP1 110a and the further multi-antenna AP2 110b may be configured to store data and executable program code which, when executed by the processing circuitry 111a,b causes the multi-antenna AP1 110a and/or the further multi-antenna AP2 110b to perform the functions, operations and methods described herein.

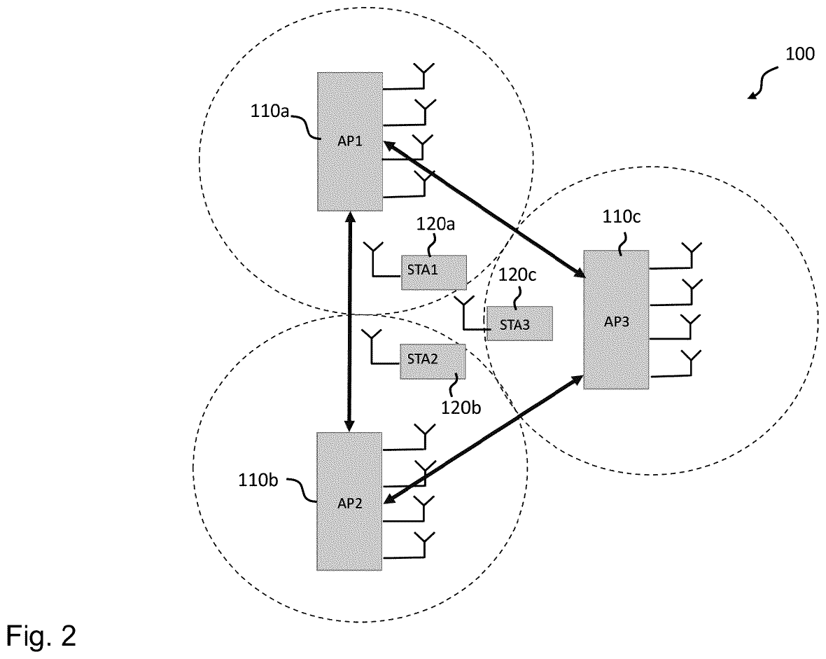

FIG. 2 shows a further embodiment of the Wi-Fi network 100, including in addition to the multi-antenna APs AP1 and AP2 110a,b a further multi-antenna AP3 110c. In the embodiment shown in FIG. 2, one station 120a-c for the purpose of determining the quantities for the JT is assigned to, in particular associated with each of the multi-antenna APs 110a-c, wherein each station 120a-c is located close to the edge of the covering range of its associated multi-antenna AP 110a-c and close to the edges of the covering ranges of the other multi-antenna APs 110a-c.

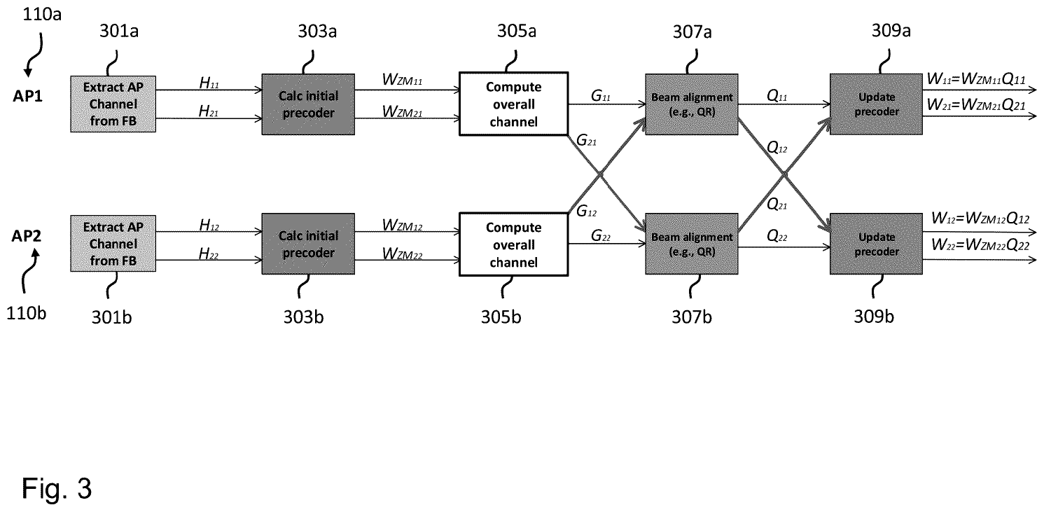

As will be described in more detail under further reference to FIG. 3, which illustrates schematically processing steps and a data exchange implemented by the multi-antenna AP1 110a and the further multi-antenna AP2 110b of the embodiment of FIG. 1, the multi-antenna AP1 110a and the further multi-antenna AP2 110b are configured to perform a joint transmission, JT, to STA1 and STA2 120a,b. This is schematically illustrated in FIG. 1, where the AP1 110a and the further AP2 110b generate concurrently a plurality of transmission beams interfering at STA1 120a and STA2 120b in such a way that both STA 120a and STA2 120c receive a joint transmission from AP1 110a and AP2 110b. As already mentioned above, in the embodiment shown in FIG. 2 this joint transmission includes one further multi-antenna AP3 110c and its associated station STA3 120c.

In a processing stage 301a of FIG. 3, the multi-antenna AP1 110a is configured to obtain channel information (represented by a channel matrix) for each of the stations STA1 and STA2 120a,b, i.e. information about the physical properties of the respective communication channels between the AP1 110a and the stations STA1 and STA2 120a,b, respectively. More specifically, the multi-antenna AP1 110a is configured to obtain the channel matrix H₁₁ describing the physical properties of the communication channel between the AP1 110a and the STA1 120a and the channel matrix H₂₁ describing the physical properties of the communication channel between the AP1 110a and the STA2 120b. In a further embodiment, described in more detail below, the multi-antenna AP1 110a is configured to obtain instead of the full channel information (described, for instance, by the channel matrix H₁₁) a partial channel information based on the matrices V and S from a singular value decomposition (SVD).

Likewise, in a processing stage 301b of FIG. 3, the multi-antenna AP2 110b is configured to obtain channel information (represented by a channel matrix) for each of the stations STA1 and STA2 120a,b, i.e. information about the physical properties of the respective communication channels between the AP2 110b and the stations STA1 and STA2 120a,b, respectively. More specifically, the multi-antenna AP2 110b is configured to obtain the channel matrix H₂₂ describing the physical properties of the communication channel between the AP2 110b and the STA2 120b and the channel matrix H₁₂ describing the physical properties of the communication channel between the AP2 110b and the STA1 120a. As illustrated in FIG. 3, in an embodiment, the APs AP1 and AP2 110a,b may be configured to extract the channel information from feedback received from the stations STA1 and STA2 120a,b in response to a sounding signal, for instance, a NDP.

In a processing stage 303a of FIG. 3, the AP1 110a is configured to determine, based on the channel information for each of the stations STA1 and STA2 120a,b, a respective precoding matrix (referred to as initial precoder in FIG. 3) for a beamed transmission to each of the stations STA1 and STA2 120a,b with substantially zero multi-user interference, MUI, at the respective station 120a,b. More specifically, the AP1 110a is configured to generate the precoding matrix W_{ZM11} for the beamed transmission to the STA1 120a and the precoding matrix W_{ZM21} for the beamed transmission to the STA2 120b. Likewise, in a processing stage 303b of FIG. 3, the AP2 110b is configured to determine, based on the channel information for each of the stations STA1 and STA2 120a,b, a respective precoding matrix (referred to as initial precoder in FIG. 3) for a beamed transmission to each of the stations STA1 and STA2 120a,b with substantially zero multi-user interference, MUI, at the respective station 120a,b. More specifically, the AP2 110b is configured to generate the precoding matrix W_{ZM22} for the beamed transmission to the STA2 120b and the precoding matrix W_{ZM12} for the beamed transmission to the STA1 120a.

As will be appreciated, as far as the feedback from the stations STA1 and STA2 120a,b is concerned, the multi-antenna APs 110a,b may be considered as one single “super AP” with distributed Tx antennas. In an embodiment, partial channel information from the STAs 120a,b to the super AP may be used by the APs 110a,b for precoder calculation in the processing stage 303a,b. Unlike the conventional JT scheme in which a master AP calculates the whole precoder (for the super AP) to yield an overall zero-MUI requirement, in the JT scheme implemented by the APs 110a,b according to an embodiment, each AP 110a,b calculates its own (zero MUI) precoder, thus guaranteeing zero MUI from each AP 110a,b despite its potential phase offset relative to the other APs participating in the JT scheme.

In a processing stage 305a of FIG. 3, the AP1 110a is configured to determine a respective overall channel matrix (referred to as overall channel in FIG. 3) for each of the stations STA1 and STA2 120a,b based on the channel information (i.e. the channel matrices describing the physical properties of the respective communication channels between the AP1 110a and the stations STA1 and STA2 120a,b, respectively) and the precoding matrix of the respective station 120a,b determined in the previous stage 303a. In an embodiment, the respective overall channel matrix may be the matrix product of the channel matrix and the precoding matrix of the respective station 120a,b. More specifically, the AP1 110a is configured to determine the overall channel matrix for STA1 120a as G₁₁=H₁₁*W_{ZM11} and the overall channel matrix for STA2 120b as G₂₁=H₂₁*W_{ZM21}. Likewise, in a processing stage 305b of FIG. 3, the AP2 110b is configured to determine a respective overall channel matrix (referred to as overall channel in FIG. 3) for each of the stations STA1 and STA2 120a,b based on the channel information (i.e. the channel matrices describing the physical properties of the respective communication channels between the AP2 110b and the stations STA1 and STA2 120a,b, respectively) and the precoding matrix of the respective station 120a,b determined in the previous stage 303b. More specifically, the AP2 110b is configured to determine the overall channel matrix for STA2 120b as G₂₂=H₂₂*W_{ZM22} and the overall channel matrix for STA1 120a as G₁₂=H₁₂*W_{ZM12}.

As illustrated in FIG. 3, in the processing stage 305a the AP1 110a is further configured to transmit the overall channel matrix G₂₁ for the station STA2 120b assigned to the AP2 110b to the AP2 110b. Likewise, in the processing stage 305b the AP2 110b is further configured to transmit the overall channel matrix G₁₂ for the station STA1 120a assigned to the AP1 110a to the AP1 110a. In other words, in the embodiment illustrated in FIG. 3, the AP1 110a receives the overall channel matrix G₁₂ for the channel between AP2 110b and the station STA1 120a from AP2 110b, while the AP2 110b receives the overall channel matrix G₂₁ for the channel between AP1 110a and the station STA2 120b from AP1 110a. In a further embodiment, the AP1 and the AP2 110a,b may be configured to determine all of the overall channel matrices themselves.

In a processing stage 307a of FIG. 3, the AP1 110a is configured to determine for each of the stations assigned to AP1 110a, i.e. STA1 120a a weighting matrix Q₁₁ for itself and a weighting matrix Q₁₂ for the AP2 110b based on the overall channel matrix G₁₁ determined by the AP1 110a and the further overall channel matrix G₁₂ received from the AP2 110b. As will be described in more detail below, in an embodiment the AP1 110a is configured to determine the weighting matrices Q₁₁ and Q₁₂ for its assigned station STA1 120a based on a beam alignment. Likewise, in a processing stage 307b of FIG. 3, the AP2 110b is configured to determine for its assigned station STA2 120b a further weighting matrix Q₂₂ for itself and a further weighting matrix Q₂₁ for the AP1 110a based on the further overall channel matrix G₂₂ determined by the AP2 110b and the overall channel matrix G₂₁ received from the AP1 110a. As will be described in more detail below, the processing stage 307a,b allows, once zero MUI in the presence of phase-offsets has been achieved by the processing stage 303a,b, to combine the precoders of each AP 110a,b so as to increase, in particular maximize the SNR at the stations STA1 and STA2 120a,b using beam alignment.

As illustrated in FIG. 3, in the processing stage 307a the AP1 110a is further configured to transmit the weighting matrix Q₁₂ for the transmission of AP2 110b to the station STA1 120a assigned to the AP1 110a to the AP2 110b. Likewise, in the processing stage 307b the AP2 110b is further configured to transmit the weighting matrix Q₂₁ for the transmission of AP1 110a to the station STA2 120b assigned to the AP2 110b to the AP1 110a. In other words, in the embodiment illustrated in FIG. 3, the AP1 110a receives the weighting matrix Q₂₁ for the transmission over the channel between AP1 110a and the station STA2 120b from AP2 110b, while the AP2 110b receives the weighting matrix Q₁₂ for the transmission over the channel between AP2 110b and the station STA1 120a from AP1 110a.

In a processing stage 309a of FIG. 3, the AP1 110a is configured to determine, i.e. compute for the transmission to station STA1 120a assigned to the AP1 110a a weighted, i.e. updated precoding matrix W₁₁ based on the precoding matrix W_{ZM11} determined in processing stage 303a and the weighting matrix Q₁₁ determined by the AP1 110a for the station STA1 120a in processing stage 307a. Moreover, the AP1 110a is configured to determine, i.e. compute for the transmission to station STA2 120b assigned to the AP2 110b a weighted precoding matrix W₂₁ based on the precoding matrix W_{ZM21} determined in processing stage 303a and the further weighting matrix Q₂₁ received from the AP2 110b in processing stage 307b. In an embodiment, the AP1 110a may compute the weighted, i.e. updated precoding matrix by means of a matrix product of the weighting matrix and the precoding matrix. Likewise, in a processing stage 309b of FIG. 3, the AP2 110b is configured to determine, i.e. compute for the transmission to station STA2 120b assigned to the AP2 110b a weighted, i.e. updated precoding matrix W₂₂ based on the precoding matrix W_{ZM22} determined in processing stage 303b and the further weighting matrix Q₂₂ determined by the AP2 110b for the station STA2 120b in processing stage 307b. Moreover, the AP2 110b is configured to determine, i.e. compute for the transmission to station STA1 120a assigned to the AP1 110a a weighted precoding matrix W₁₂ based on the precoding matrix W_{ZM12} determined in processing stage 303b and the weighting matrix Q₁₂ received from the AP1 110a in processing stage 307a.

Based on the weighted, i.e. updated precoding matrix W₁₁, W₂₁ for each of the stations STA1 and STA2 120a,b the AP1 110a is configured to perform a joint transmission with the AP2 110b to the stations STA1 and STA2 120a,b.

Further mathematical details of the embodiments shown in FIGS. 1 to 3, will be described in the following by considering the case of N_{AP} APs 110a-c jointly transmitting to N_{STA} STAs 120a-c with N_{S} streams being transmitted per STA 120a-c. Each AP 110a-c has N_{T} TX antennas and each STA 120a-c has N_{R} RX antennas, where N_{T}N_{AP}≥N_{S}N_{STA} and N_{R}≥N_{S}. As will be appreciated, embodiments of the present disclosure are no limited to the case that all APs 110a-c and all stations 120a-c have the same number of antennas. This assumption is only made for the sake of clarity for describing the following example. However, firstly, for each AP 110a-c the number of TX antennas is greater than or equal to the total number of streams that are transmitted by the respective AP 110a-c to the plurality of STAs 120a-c (i.e. streams in which the respective AP 110a-c participates in the joint-transmission). Secondly, for each STA 120a-c the number of RX antennas of the respective STA 120a-c is greater than or equal to the total number of streams that are jointly transmitted to the respective STA 120a-c by the plurality of APs 110a-c.

In an embodiment, the plurality of APs 110a-c may first jointly transmit a sounding signal, in particular a NDP to the plurality of STAs 120a-c. The plurality of STAs 120a-c calculate feedback to the NDP by treating all the APs 110a-c as a single “super AP” with N_{AP}N_{T} distributed antennas. The feedback from each STA 120a-c includes channel information, which may comprise partial or full channel information. The feedback may not be necessarily calculated for all subcarriers (SCs) of the sounding signal for reducing the feedback overhead but may be calculated on a subset of SCs only (which are referred to as “decimated SCs”). The decimation factor N_{g} defines the ratio between the number of all SCs and the number of decimated SCs.

As already mentioned above, H_{i,j} denotes the channel, i.e. the channel matrix representing the channel from the j-th AP to i-th STA, with the overall channel Hᵢ=└H_{i,1} H_{i,2} . . . H_{i,N}_{_{AP}}┘. Usually, the channel Hᵢ is a N_{R}×N_{AP}N_{T} matrix.

Each of the plurality of STAs 120a-c may send to the plurality of APs 110a-c the partial channel information determined by treating the plurality of APs 110a-c as a single super AP. In one embodiment, the partial channel information may be calculated similarly to the Wi-Fi standard for the single AP case, i.e., each STA 120a-c performs a singular value decomposition (SVD) Hᵢ=USV^{H} of the channel from the super AP to itself and transmits the first N_{req} diagonal elements of s (ordered from largest to smallest) and the corresponding N_{req} columns of V, possibly compressed (N_{req}=number of streams requested in the feedback from the STA 120a-c) and possibly transmitted only for the decimated SCs (if N_{g}>1).

In the following \tilde{S} denotes a diagonal matrix whose entries are the first N_{S} elements of s and \tilde{V} denotes a matrix made up of the first N_{S} columns of v. As will be appreciated, N_{S} may be smaller than N_{req}, i.e., the number of streams transmitted per STA 120a-c may be smaller than the number of streams requested from that STA 120a-c during the sounding procedure.

The j-th AP 110a-c determines from the feedback its component of the partial channel information for the i-th STA 120a-c, i.e. \tilde{H}_{i,j}=\tilde{S}\tilde{V}ⱼ^{H}, where \tilde{v}ⱼ is the j-th N_{T}×N_{S} block of \tilde{V} and the blocks are arranged row-wise. As will be appreciated, in this case the number of rows of the matrices \tilde{H}_{i,j} is N_{S} (and not N_{R} as in the full channel case). As will be further appreciated embodiments disclosed herein are not limited to the type of feedback from the STAs 120a-c as defined by the current Wi-Fi standards, but may encompass other types of feedback from the STAs 120a-c as well. For instance, in an embodiment, each STA 120a-c may transmit the full channel information Hᵢ as feedback, and the j-th AP 110a-c may calculate \tilde{H}_{i,j} by performing SVD and the steps described above.

As already described above, in a next processing stage, the APs 110a-c then calculate a precoder represented by a precoding matrix based on the feedback from the plurality of STAs 120a-c. In the following description Wᵢⱼ denotes the precoding matrix representing the precoder from the j-th AP to the i-th STA with Wᵢ=└W_{i,1} W_{i,2} . . . W_{i,N}_{_{AP}}┘.

As already described above, each STA 120a-c is assigned to, in particular associated with one of the APs 110a-c. For instance, in the embodiment shown in FIG. 2, the STA1 120a, STA2 120b and STA3 120c are associated with AP1 110a, AP2 110b and AP3 110c, respectively. In an embodiment, each AP 110a-c, before transmitting data by means of a joint transmission to its associated STA 120a-c, may transmit the data to the other APs 110a-c via a separate communication channel (for instance, by means of a wired backbone connection between the APs 110a-c, as indicated in the embodiment shown in FIG. 2).

In the following some further mathematical details of the processing steps implemented by the AP 110a according to an embodiment will be described in more detail. For the sake of a better understanding these details will be described initially for the simple example of having two APs 110a,b and two STAs 110a,b (as illustrated in the embodiment of FIG. 1), wherein each STA 110a,b is equipped with one RX antenna and receives one spatial stream, i.e. N_{S}=1.

For the following example yᵢ denotes the signal at the i-th STA 120a,b, h_{i,j}^{T} denotes the channel from the j-th AP 110a,b to i-th STA 120a,b, w_{i,j} denotes the precoder of the j-th AP 110a,b for the i-th STA 120a,b, sᵢ denotes the stream jointly transmitted to the i-th STA 120a,b, ϕ denotes the phase offset between the APs 110a,b, and vᵢ denotes the AWGN noise at the i-th STA 120a,b. In this case, the received signal at STA1 110a may be expressed by means of the following equation:

$${y}_{1} = [ {h}_{1 , 1}^{T} {h}_{1 , 2}^{T} ] ( [ \begin{matrix}{w}_{1 , 1} \\ {e}^{j ϕ} {w}_{1 , 2}\end{matrix} ] {s}_{1} + [ \begin{matrix}{w}_{2 , 1} \\ {e}^{j ϕ} {w}_{2 , 2}\end{matrix} ] {s}_{2} ) + {v}_{1} = ( {h}_{1 , 1}^{T} {w}_{1 , 1} + {e}^{j ϕ} {h}_{1 , 2}^{T} {w}_{1 , 2} ) {s}_{1} + ( {h}_{1 , 1}^{T} {w}_{1 , 1} + {e}^{j ϕ} {h}_{1 , 2}^{T} {w}_{1 , 2} ) {s}_{1} + {v}_{1} .$$

As can be appreciated from this equation, if the APs 110a,b determine the precoders such that w_{2,1}∈null(h_{1,1}^{T}), w_{2,2}∈null(h_{1,2}^{T}), then this implies that substantially zero multi-user interference (MUI) is achieved at STA1 110a regardless of the phase offset ϕ between the APs 110a,b.

Likewise, the APs 110a,b may determine the further precoders such that w_{1,1}∈null(h_{2,1}^{T}), w_{1,2}∈null(h_{2,2}^{T}). For this choice of the precoders by the APs 110a,b the precoders may be expressed in the following way:

$${w}_{1 , 1} = {n}_{2 , 1} {α}_{1 , 1} , {w}_{2 , 1} = {n}_{1 , 1} {α}_{2 , 1}$$

$${w}_{1 , 2} = {n}_{2 , 2} {α}_{1 , 2} , {w}_{2 , 2} = {n}_{1 , 2} {α}_{2 , 2} ,$$

where n_{i,j} denotes a unit-norm vector that belongs to the null-space of h_{i,j}^{T}. In an embodiment, the APs 110a,b may be configured to determine the unit-norm vectors belonging to the null-space of h_{i,j}^{T}, for instance, by performing a pseudo-inverse precoding to the sub-problems (namely [h_{1,1}^{T} h_{2,1}^{T}]).

With this choice of the precoders by the APs 110a,b the received signal at STA1 120a becomes:

$${y}_{1} = ( {h}_{1 , 1}^{T} {w}_{2 , 1} {α}_{1 , 1} + {e}^{j ϕ} {h}_{1 , 2}^{T} {w}_{2 , 2} {α}_{1 , 2} ) {s}_{1} + 0 + {v}_{1} .$$

In an embodiment, the APs 110a,b are configured to determine the proportionality parameters α_{1,1},α_{1,2} (with respect to phase and magnitude) in such a way as to increase, in particular maximize the SNR (for example, for a phase offset ϕ=0) under the (total) power constraint. In an embodiment, the APs 110an may be configured to determine the proportionality parameters α_{1,1},α_{1,2} in such a way based on a Maximum Ratio Transmission, MRT, scheme, which may yield:

$${α}_{1 , 1} = \frac{{h}_{1 , 1}^{H} {n}_{2 , 1}^{*}}{{\vert {h}_{1 , 1}^{T} {n}_{2 , 1} \vert}^{2} + {\vert {h}_{1 , 2}^{T} {n}_{2 , 2} \vert}^{2}}$$

$${α}_{1 , 2} = \frac{{h}_{1 , 2}^{H} {n}_{2 , 2}^{*}}{{\vert {h}_{1 , 1}^{T} {n}_{2 , 1} \vert}^{2} + {\vert {h}_{1 , 2}^{T} {n}_{2 , 2} \vert}^{2}}$$

As will be appreciated, the joint transmission scheme described above may be regarded from a slightly different perspective in the following way. The AP1 110a is performing a MU-MIMO with STA1 120a and STA2 120b using zero-MUI precoding (e.g., pseudo-inverse precoding). Likewise, the AP2 110b is performing a MU-MIMO with STA1 120a and STA2 120b using zero-MUI precoding (e.g., pseudo-inverse precoding). As the APs 110a,b perform the MU-MIMO concurrently this is a JT scheme. As will be appreciated, zero MUI is maintained regardless of the phase error. It is only left for the APs to align the beams so as to maximize the SNR (for the case of no phase-offset between the APs).

Having described a simple example for illustrative purposes above, in the following some more details for more general JT scenarios will be described, such as scenarios with more than one spatial stream and an arbitrary number of APs 110a-c and STAs 120a-c. Also for these more general JC scenarios each AP 110a-c according to an embodiment may determine for each decimated SC a zero-MUI precoder, i.e. precoding matrix for the single AP downlink MU-MIMO case (which is herein referred to as W^{ZM}) by ignoring the potentially interfering signals of the other APs 110a-c. This approach implemented by the APs 110a-c according to an embodiment may guarantee a substantially zero MUI even in the presence of a phase offset between the APs 110a-c. As will be appreciated, the APs 110a-c according to an embodiment may determine the precoder, i.e. the precoding matrix in a number of different ways with the constraint that the precoder, i.e. precoding matrix from the j-th AP 110a-c to the i-STA 120a-c W_{i,j} is spanned by null ([\tilde{H}_{1,j}^{T} . . . \tilde{H}_{i-1,j}^{T} \tilde{H}_{i+1,j}^{T} . . . \tilde{H}_{N}_{_{STA}}_{,j}^{T}]^{T}).

As already described above, in an embodiment, the APs 110a-c may be configured to determine the pseudo-inverse precoder as suitable precoder fulfilling the constraint described above. However, other suitable zero-MUI precoders are known, which may have a better performance than the pseudo-inverse precoder in the case of more than one spatial stream per STA 120a-c.

As already described above in the context of the illustrative simple example, in a further processing stage the APs 110a-c may optimize the performance of the zero-MUI precoder fulfilling the constraint described above by increasing, in particular maximizing a post-processing SNR (herein referred to as ppSNR) at the respective STA 120a-c in some sense. As will be appreciated, the ppSNR usually depends on the phase offset between the plurality of APs 110a-c, which is generally unknown. Therefore, in an embodiment, the APs 110a-c are configured to determine the suitable zero-MUI precoders in such a way that the ppSNR is increased, in particular maximized for the case of no phase offset. This approach implemented by the APs 110a-c according to an embodiment is beneficial for the following reasons. Firstly, this approach ensures that the JT scheme implemented by the APs 110a-c according to an embodiment is as close as possible to the conventional JT scheme in the case of no phase-offset (or just a small phase offset), so that the negative gain in the case of perfect synchronization will be kept relatively small. Secondly, from symmetry considerations, as for each possible phase offset ϕ, the same negative phase offset −ϕ is equally probable, an optimization for the case ϕ=0 makes the most sense. Thirdly, it is well known that the “nulls” of precoders are very sensitive to channel variations and phase offsets, but the beams are much less sensitive (nulls are narrow and beams are wide). Thus, even if the ppSNR is optimized for ϕ=0, the performance will remain good at least for moderate phase offsets.

For determining the suitable zero-MUI precoders in such a way that the ppSNR is increased, in particular maximized for the case of no phase offset the APs 110a-c according to an embodiment may use different kind of metrics. For instance, in the case of more than one spatial stream per STA 120a-c, the APs 110a-c according to an embodiment may maximize the metric |det(HᵢWᵢ)| for each decimated SC for determine the optimized zero-MUI precoders. Such a choice for the metric allows maximizing the capacity in the high SNR regime.

As already described above, once the k-th AP 110a-b has determined its zero-MUI precoder in the way described above, it may determine for each STA 120a-b the overall channel, i.e. the product of the channel matrix and the precoding matrix Gᵢₖ=\tilde{H}ᵢₖWᵢₖ^{ZM}.

As already described above, each STA 120a-c is assigned to one of the APs 110a-c, which may be referred to as the master AP 110a-c of the respective STA 120a-c. In one embodiment the master AP 110a-c of an STA 120a-c is the AP 110a-c to which the STA 120a-c is associated. This is natural and efficient if the STAs 120a-c are roughly uniformly associated to the APs 110a-c. In other embodiments the STAs 120a-c may be distributed among the master APs 110a-c in a different way. For example, if the STAs 120a-c are not uniformly associated with the APs 110a-c, the STAs 120a-c may be assigned to the master APs 110a-c (for sake of the precoder calculation by the APs 110a-c) in a uniform manner so as to reduce the computational complexity per AP 110a-c for determining the precoders.

As already described above, in a further processing stage, the k-th AP 110a-c may transmit the overall channel Gᵢₖ to the master AP 110a-c of the i-th STA 120a-c (for instance, for each decimated SC). In the next stage, the master AP 110a-c of the i-th STA 120a-c combines the overall channels received from the APs Gᵢ=└Gᵢ₁ . . . G_{iN}_{_{AP}}┘ and performs “beam alignment” by calculating a beam alignment matrix Qᵢ (for each decimated SC). In a further processing stage, the weighting matrices Qᵢₖ (for k=1, . . . , N_{AP}) may be derived from the Qᵢ matrix, where Qᵢₖ is the k-th N_{S}×N_{S} block of the matrix Qᵢ, and the blocks are arranged row-wise. The weighting matrices Qᵢₖ are used by the k-th AP 110a-c. In an embodiment, the matrix Qᵢ may be determined using a QR decomposition Gᵢ^{H}=QᵢRᵢ. In fact, the QR decomposition used according to an embodiment for beam alignment may be the optimal solution for the chosen ppSNR metric since it maximizes |det(\tilde{H}ᵢWᵢ^{ZM})|.

In an embodiment, the master AP 110a-c of each STA 120a-c may perform a phase alignment algorithm on the beam alignment matrix Qᵢ. In case the decimation factor is larger than 1, i.e. in the case N_{g}>1, the phase alignment may be followed by an interpolation for determining the beam alignment matrix Qᵢ for all SCs. In an embodiment, where the APs 110a-c are configured to use a QR decomposition for the phase alignment, the phase alignment algorithm may be based on Qᵢ and/or Rᵢ.

As already described above, each master AP 110a-c is configured to transmit its component, i.e. the weighting matrix Qᵢₖ to each other AP 110a-c. Thus, each AP 110a-c receives all weighting matrices Qᵢₖ and may determine based thereon the respective overall precoder (possibly over the decimated SCs only) for each STA 120a-c as

WᵢₖWᵢₖ^{ZM}Qᵢₖ.

In an embodiment, where the decimation factor is larger than 1, i.e. in the case Ng>1, each AP 110a-c may interpolate its overall precoder from the decimated SCs to all the active SCs. As will be appreciated, performing the interpolation at this late processing step allows keeping the traffic over the separate channels between the APs 110a-c to a minimum. As will be further appreciated, the QR decomposition performed in an embodiment by each AP 110a-c (if done for the sake of beam-alignment, as stipulated by embodiments disclosed herein) may provide a rather good phase alignment, which may be beneficial for the interpolation over all SCs and for a channel estimation smoothing performed at the STAs 120a-c. Since, in an embodiment, the overall precoder matrix from the APs 110a-c to the i-th STA 120a-c is Rᵢ and since the diagonal elements of Rᵢ are real, the phase difference of the diagonal of Rᵢ over the decimated SCs is zero. Thus, the overall phase difference between columns of Rᵢ over the decimated SCs may be rather small, and a phase alignment could be omitted with rather small performance loss.

As will be appreciated, in an embodiment, where the decimation factor is larger than 1, i.e. in the case Ng>1, the JT scheme implemented by the APs 110a-c according to an embodiment guarantees zero MUI on the decimated SCs. However, some MUI may build up on the other SCs due to the interpolation over the decimated SCs. As will be further appreciated, exactly zero MUI may be achieved when the respective communication channel between the APs 110a-c and the STAs 120a-c is perfectly known. In practice, however, generally channel estimates with an inherent noise are used as channel information. Thus, in practice, even on the decimated SCs there may be MUI to some small degree. Thus, as will be appreciated, the JT scheme implemented by the APs 110a-c according to an embodiment may referred to as “zero MUI robust joint transmission” in the sense that the JT scheme implemented by the APs 110a-c according to an embodiment is based on zero MUI precoders for each AP 110a-c and yields a substantially zero MUI at the plurality of STAs 120a-c.

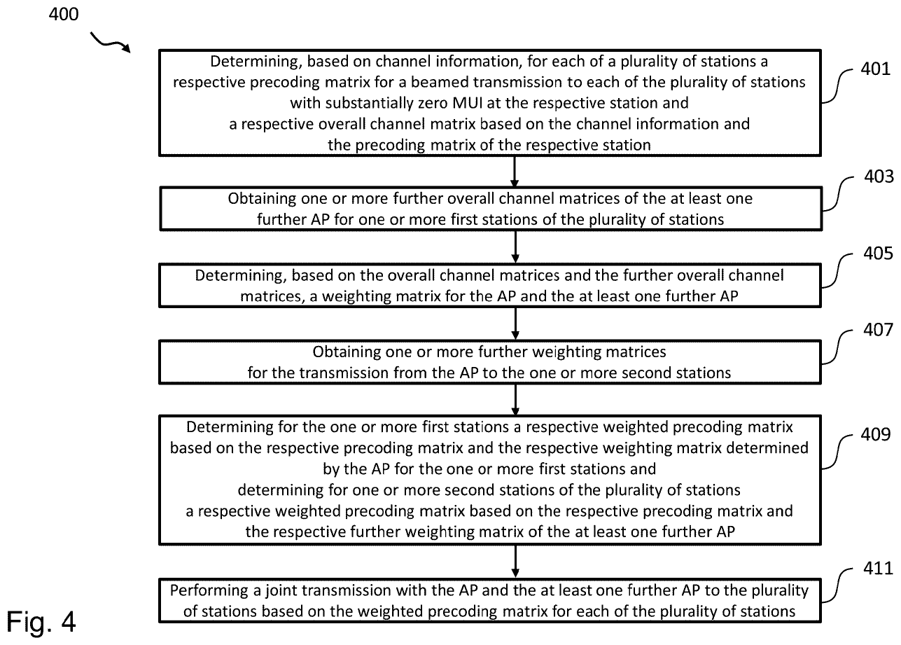

FIG. 4 shows a flow diagram illustrating steps of a method 400 for performing a joint transmission with the AP1 110a and at least the AP2 110b to the stations STA1 and STA2 120a,b. The method 400 comprises a step 401 of determining, based on channel information for each of the stations STA1 and STA2 120a,b, for each of the stations STA1 and STA2 120a,b a respective precoding matrix for a beamed transmission to each of the stations STA1 and STA2 120a,b with substantially zero multi-user interference, MUI, at the respective station 120a,b and a respective overall channel matrix based on the channel information and the precoding matrix of the respective station 120a,b.

Moreover, the method 400 comprises a step 403 of obtaining one or more further overall channel matrices of the AP2 110b for the station STA1 120a assigned to the AP1 110a. In an embodiment, obtaining the one or more further overall channel matrices may comprise receiving the one or more further overall channel matrices of the AP2 110b for the station STA1 120a assigned to the AP1 110a from the AP2 110b.

The method 400 further comprises a step 405 of determining, based on the one or more overall channel matrices and the one or more further channel matrices, for the AP1 110a and the AP2 110b a respective weighting matrix for the transmission to STA1 120a assigned to the AP1 110a.

Moreover, the method 400 comprises a step 407 of obtaining one or more further weighting matrices for the transmission from the AP1 110a to the station STA2 120b assigned to the AP2 110b. In an embodiment, obtaining the one or more further weighting matrices may comprise receiving the one or more further weighting matrices from the AP2 110b.

The method 400 further comprises a step 409 of determining for the station STA1 120a assigned to the AP1 110a a respective weighted precoding matrix based on the respective precoding matrix and the respective weighting matrix determined by the AP1 110a for the station STA1 120a assigned to the AP1 110a and determining for the station STA2 120b assigned to the AP2 110b a respective weighted precoding matrix based on the respective precoding matrix and the respective further weighting matrix of the AP2 110b.

Moreover, the method 400 comprises a step 411 of performing a joint transmission with the AP1 110a and the AP2 110b to the stations STA1 and STA2 120a,b based on the weighted precoding matrix for each of the stations STA1 and STA2 120a,b.

As the method 400 can be implemented by the APs 110a-c, further features of the method 400 result directly from the functionality of the APs 110a-c and their different embodiments described above and below.

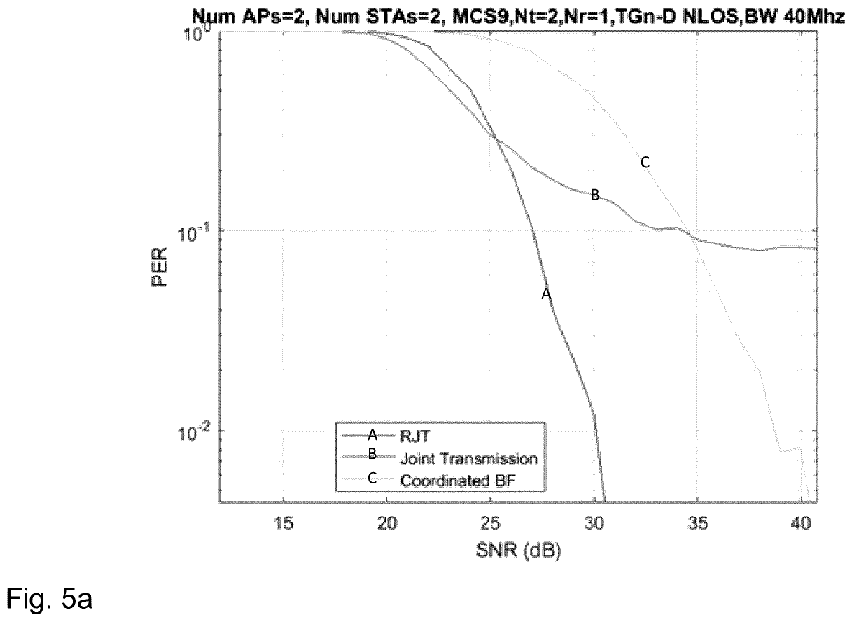

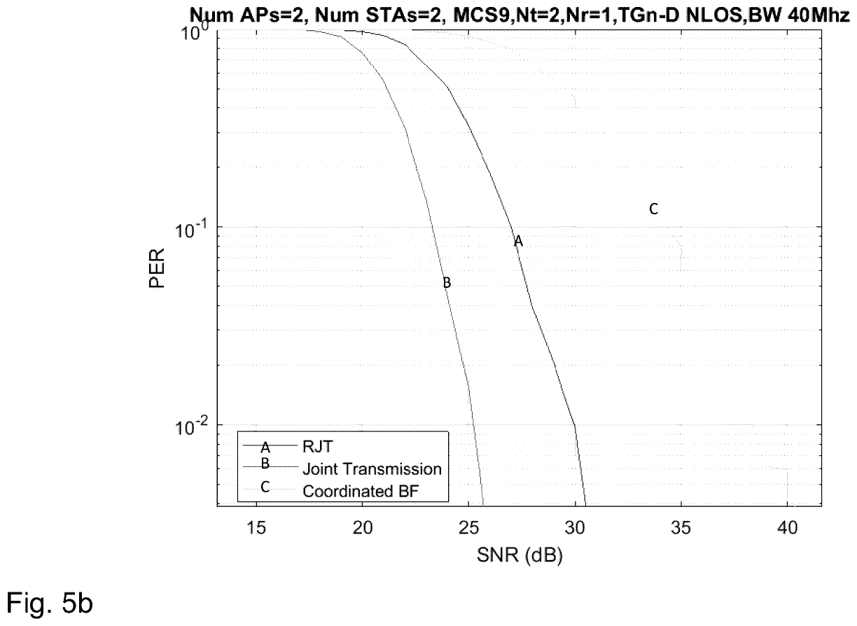

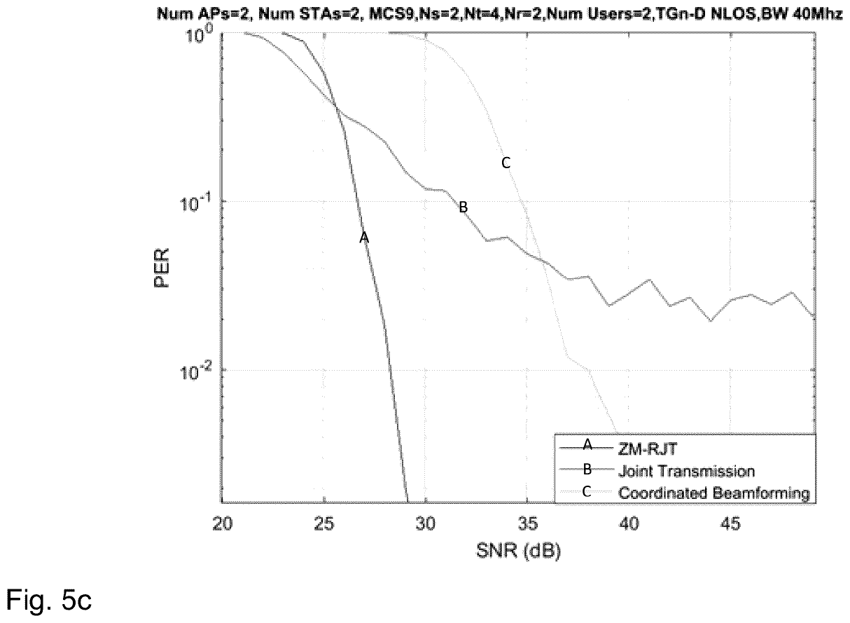

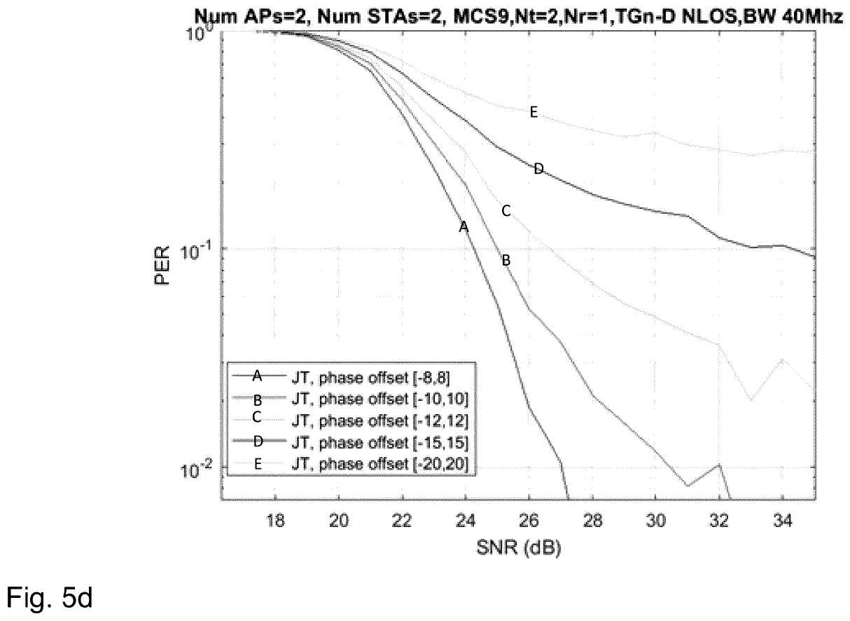

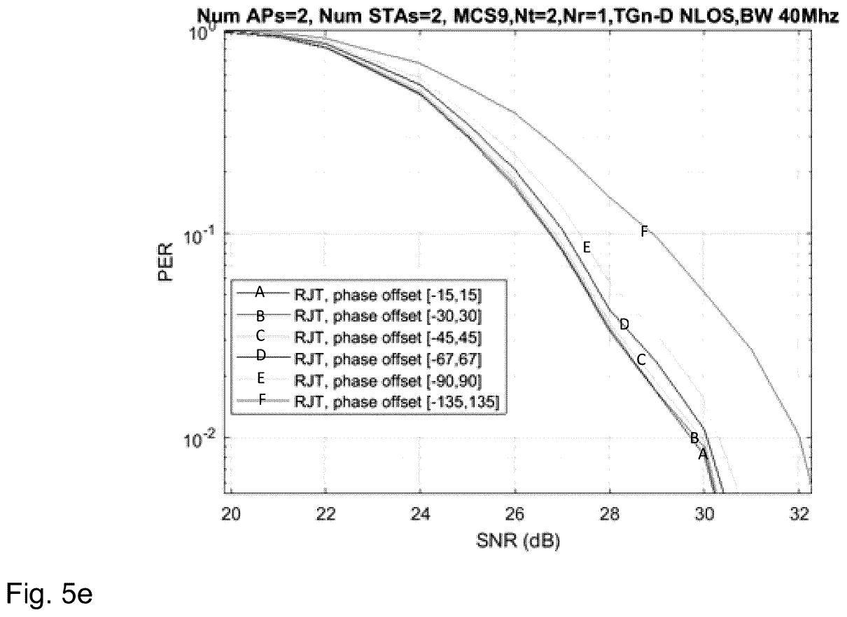

FIGS. 5a-5e show different graphs illustrating the performance (more specifically the dependency of the packet error rate, PER, on the SNR) of the joint transmission scheme implemented by the APs 110a-c according to an embodiment (referred to as RJT or ZM-RJT in FIGS. 5a-5e) relative to a conventional joint transmission (JT) scheme and a conventional coordinated beamforming (CoBF) scheme. The results illustrated in FIGS. 5a-5e are based on a transmission scenario with two APs with two Tx antennas each transmitting over 40 Mhz BW with the Wi-Fi modulation and coding scheme MCS9 to two STAs with one Rx antenna each. The channel which is used in the simulation is TGn-D NLOS.

FIG. 5a illustrates the performance of the JT scheme implemented by the APs 110a-c according to an embodiment compared to the conventional JT scheme and the conventional CoBF scheme in the presence of phase offsets that are uniformly distributed in the interval [−15,15] degrees. As can be taken from FIG. 5a, the JT scheme implemented by the APs 110a-c according to an embodiment is very robust to phase offsets and provides a gain of more than 7 dB relative to the conventional CoBF scheme in the presence of moderate phase offsets. Moreover, the JT scheme implemented by the APs 110a-c according to an embodiment provides a gain of more than 7 dB relative to the conventional JT scheme with phase offsets in the range of [−15,15] or greater.

FIG. 5b illustrates the performance of the JT scheme implemented by the APs 110a-c according to an embodiment compared to the conventional JT scheme and the conventional CoBF scheme with no phase offsets. As can be taken from FIG. 5b, the JT scheme implemented by the APs 110a-c according to an embodiment provides a gain of more than 7 dB gain relative to the conventional CoBF scheme and closes a large part of the gap between the conventional CoBF and the conventional JT scheme, while being robust to phase offsets between the APs 110a-c.

FIG. 5c illustrates the performance of the JT scheme implemented by the APs 110a-c according to an embodiment compared to the conventional JT scheme and the conventional CoBF scheme for the case of two spatial streams being jointly transmitted by the two APs to the two STAs. As can be taken from FIG. 5c, the JT scheme implemented by the APs 110a-c according to an embodiment provides a gain of more than 8 dB in comparison with the conventional CoBF scheme and a gain of almost 5 dB in comparison with the conventional JT scheme in the case of phase offsets that are uniformly distributed in the range of [−15,15] degrees. As will be appreciated, the performance gain relative to the conventional JT scheme becomes even more pronounced for larger phase offsets.

FIGS. 5d and 5e illustrate that the JT scheme implemented by the APs 110a-c according to an embodiment allows easing the synchronization requirement of the conventional JT scheme. More specifically, FIG. 5d shows the performance of the conventional JT scheme for different phase offset distributions, where the phase offsets are uniformly distributed in the different ranges indicated in FIG. 5d. FIG. 5e shows the performance of the JT scheme implemented by the APs 110a-c according to an embodiment for the same phase offset distributions as in FIG. 5d.

The increased robustness of the JT scheme implemented by the APs 110a-c according to an embodiment relative to the conventional JT scheme is clearly evident from FIGS. 5d and 5e. The JT scheme implemented by the APs 110a-c according to an embodiment can support phase offsets of up to about 45 degrees with very small degradation relative to the case of no phase offset. Even offsets of up to 90 degrees do not cause a significant performance loss. The conventional JT scheme, however, suffers a huge performance loss already for phase offsets in the range of [−15,15] degrees. This implies that synchronization requirement is less severe for the JT scheme implemented by the APs 110a-c according to an embodiment than for the conventional JT scheme.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

1. An access point (AP) for a joint transmission with at least one further AP to a plurality of stations, including one or more first stations and one or more second stations, wherein the AP comprises:
a processor; and
a memory coupled to the processor and having processor-readable instructions stored thereon, which upon execution by the processor, cause the AP to:
determine, based on channel information for each of the plurality of stations, for each of the plurality of stations, a respective precoding matrix for a beamed transmission to each of the plurality of stations with substantially zero multi-user interference (MUI) at a respective station, and determine a respective overall channel matrix based on the channel information and a precoding matrix of the respective station;
obtain one or more further overall channel matrices of the at least one further AP for the one or more first stations;
determine, based on the one or more overall channel matrices and the one or more further overall channel matrices, for the AP and the at least one further AP, a respective weighting matrix for the transmission to the one or more first stations;
obtain one or more further weighting matrices for the transmission from the AP to the one or more second stations;
determine for the one or more first stations a respective first weighted precoding matrix based on the respective precoding matrix and the respective weighting matrix determined by the AP for the one or more first stations, and determine for the one or more second stations a respective second weighted precoding matrix based on the respective precoding matrix and a respective further weighting matrix; and
perform a joint transmission with the at least one further AP to the plurality of stations based on a weighted precoding matrix for each of the plurality of stations.

2. The AP according to claim 1, wherein the processor is further configured to execute the processor-executable instructions to cause the AP to:
transmit the one or more overall channel matrices determined by the AP for the one or more second stations to the at least one further AP and to obtain the one or more further overall channel matrices of the at least one further AP for the one or more first stations from the at least one further AP.

3. The AP according to claim 1, wherein the processor is further configured to execute the processor-executable instructions to cause the AP to:
transmit one or more of the weighting matrices determined by the AP for the transmission from the at least one further AP to the one or more first stations to the at least one further AP and to obtain one or more of the further weighting matrices for the transmission from the AP to the one or more second stations from the at least one further AP.

4. The AP according to claim 1, wherein the processor is further configured to execute the processor-executable instructions to cause the AP to:
determine for each of the one or more first stations the weighting matrix, based on the one or more overall channel matrices and the one or more further overall channel matrices, by aligning one or more intensities and/or one or more phases of a respective beamed transmission for maximizing a composite quality metric.

5. The AP according to claim 4, wherein the processor is further configured to execute the processor-executable instructions to cause the AP to:
determine for each of the one or more first stations the weighting matrix based on the one or more overall channel matrices and the one or more further overall channel matrices using a QR decomposition of the respective overall channel matrix.

6. The AP according to claim 1, wherein the processor is further configured to execute the processor-executable instructions to cause the AP to:
receive the channel information for the plurality of stations from the plurality of stations and/or from the at least one further AP.

7. The AP according to claim 1, wherein the channel information for each of the plurality of stations comprises partial channel information and/or complete channel information.

8. The AP according to claim 1, wherein the processor is further configured to execute the processor-executable instructions to cause the AP to:
transmit a sounding signal to one or more of the plurality of stations for triggering the one or more of the plurality of stations to transmit the channel information to the AP.

9. The AP according to claim 1, wherein the one or more first stations are assigned to the AP.

10. The AP according to claim 1, wherein the AP and the at least one further AP are connected by a wired and/or wireless connection.

11. A method of performing a joint transmission with at least one further AP to a plurality of stations, wherein the method applied to an access point (AP), and the plurality of stations include one or more first stations and one or more second stations, wherein the method comprises:
determining, based on channel information for each of the plurality of stations, for each of the plurality of stations, a respective precoding matrix for a beamed transmission to each of the plurality of stations with substantially zero multi-user interference (MUI) at a respective station, and determining a respective overall channel matrix based on the channel information and a precoding matrix of the respective station;
obtaining one or more further overall channel matrices of the at least one further AP for the one or more first stations;
determining, based on the one or more overall channel matrices and the one or more further channel matrices, for the AP and the at least one further AP, a respective weighting matrix for the transmission to the one or more first stations;
obtaining one or more further weighting matrices for the transmission from the AP to the one or more second stations;
determining for the one or more first stations a respective first weighted precoding matrix based on the respective precoding matrix and the respective weighting matrix determined by the AP for the one or more first stations, and determining for the one or more second stations a second respective weighted precoding matrix based on the respective precoding matrix and a respective further weighting matrix; and
performing a joint transmission with the AP and the at least one further AP to the plurality of stations based on a weighted precoding matrix for each of the plurality of stations.

12. A computer program product comprising a computer-readable storage medium for storing program code which causes a computer or a processor of an access point (AP) to perform a method of performing a joint transmission with at least one further AP to a plurality of stations, when the program code is executed by the computer or the processor; wherein the plurality of stations include one or more first stations and one or more second stations, wherein the method comprises:
determining, based on channel information for each of the plurality of stations, for each of the plurality of stations, a respective precoding matrix for a beamed transmission to each of the plurality of stations with substantially zero multi-user interference (MUI) at a respective station, and determining a respective overall channel matrix based on the channel information and a precoding matrix of the respective station;
obtaining one or more further overall channel matrices of the at least one further AP for the one or more first stations;
determining, based on the one or more overall channel matrices and the one or more further channel matrices, for the AP and the at least one further AP, a respective weighting matrix for the transmission to the one or more first stations;
obtaining one or more further weighting matrices for the transmission from the AP to the one or more second stations;
determining for the one or more first stations a respective first weighted precoding matrix based on the respective precoding matrix and the respective weighting matrix determined by the AP for the one or more first stations, and determining for the one or more second stations a second respective weighted precoding matrix based on the respective precoding matrix and a respective further weighting matrix; and
performing a joint transmission with the AP and the at least one further AP to the plurality of stations based on a weighted precoding matrix for each of the plurality of stations.
